(19) United States
(12) Patent Application Publication
(10) Pub. No.: US 2006/0107909 A1
(43) Pub. Date: May 25, 2006

(54) Equine support

(76) Inventor: Thalia Rebecca White, Surrey (GB)

Correspondence Address: Thalia Rebecca White, 10 Tally Road, Limpsfield Chart, Surrey, OXTED, RH8-OTG, GB

(21) Appl. No.: 11/329,079

(22) Filed: Jan. 11, 2006

(30) Foreign Application Priority Data
Mar. 2, 2004 (GB) 0420019.2
Mar. 2, 2004 (GB) 0420021.8
Mar. 2, 2004 (GB) 0420020.0

(51) Int. Cl. A01K 27/00

(52) U.S. Cl. 119/856

(57) ABSTRACT

An equine tendon and/or ligament support comprising a first layer of gel, a second layer of dry flex material and a third layer of lycra material.

### FIELD OF INVENTION

The present invention relates to an equine support and more especially to a tendon and/or ligament support for inter alia a horse.

### BACKGROUND INFORMATION

The tendons and ligaments in the legs of a horse are a major concern to horse owners and breeders as there is often a high risk from injury to these parts. Injuries commonly occur when the horse is put under abnormal stress or the horse's conformation is wrong. When a horse's legs are not straight, for example, stress can be caused on the joint which, in turn, puts increasing stress on the tendons and ligaments. A horse overreaching my also cause it to strike its front leg with its hind leg.

Conventionally, tendon supports are known to be made of plastic/rubber/leather or woven fabric.

The present invention sets out to provide an improved tendon and ligament support for, inter alia, a horse which compromises a gel combined with a four-way stretch lycra material.

One embodiment of the invention will now be described with reference to the accompanying Figures in which:

### BRIEF DESCRIPTION OF THE DRAWINGS

FIG. 1 is a schematic view of a horse's leg showing the tendons, ligaments and bones;

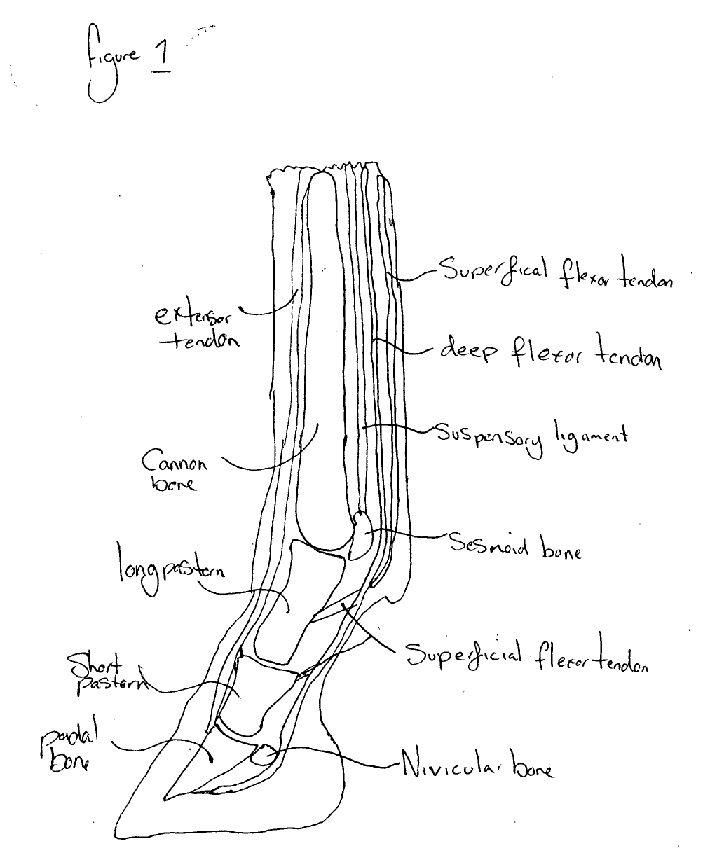

FIG. 2 is a perspective view of a first layer of a support constructed in accordance with the present invention;

FIG. 3 is a perspective view of first and second layers of the support;

FIG. 4 is a perspective view of first, second and third layers of the support;

FIG. 5 is a perspective view of the support of FIG. 4 including a zip;

FIG. 6 is a plan view of the first layer of the support when opened-out;

FIG. 7 is a plan view of the first and second layers of the support; and

FIG. 8 is a plan view of the third layer of the support showing the zip mechanism.

### DETAILED DESCRIPTION OF THE DRAWINGS

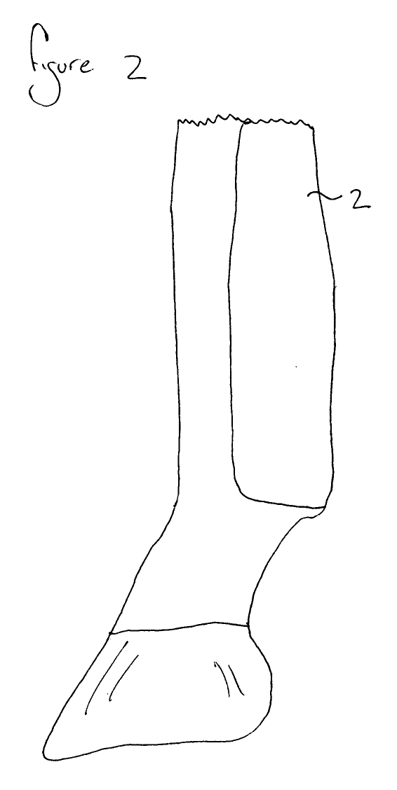

Referring first to FIG. 2, the first layer of a support comprises a gel 2 which, in use is placed on to the leg 1 of a horse. The gel 2 is formed with an outer silicone skin to keep the gel 2 from leaking down the leg 1 of the horse. The gel 2 is preferably a tacky clear gel such as that marketed as MED-6345. MED-6345 is a medium viscosity liquid that cures to a soft, high penetration resistance gel.

The gel 2 is placed on the horse's leg 1 so to surround the back part of the leg 1 from below the back of knee to just above the fetlock joint. The gel 2 moulds to the leg 1 to provide tendon and/or ligament support while also acting partly as a shock absorber providing high impact resistance.

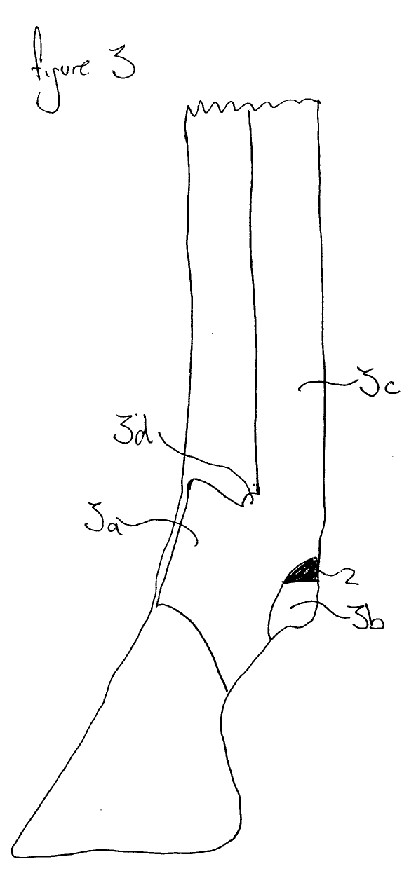

Referring now to FIG. 3. The second layer of the support comprises a dry flex material located over the gel 2. The dry flex material extends upwardly from the fetlock below which the gel 2 is not present. The dry flex is made from a thermoplastic elastomer such as styrene-ethylene-butadiene-styrene (SEBS) block copolymer blended with polypropylene. This material is similar to rubber but has the advantage of being non-perishable more flexible.

The shape and design of the front portion 3a of the support is such that it allows the front of the fetlock joint to move freely, while at the same time supporting both sides to prevent and excessive flexing.

An aperture 3b is formed in the back portion of the support. The aperture 3b is approximately two inches by two inches depending on the size of the horse. The aperture 3b provides an area in the support through which the back of fetlock joint can protrude. This allows the joint to flex, but stops the joint over flexing. A mid-portion of the support has a semi-circular formation 3d. This formation 3d retains the dry flex in place when the tendons are at a high stress level at this part of the dry flex material.

The top portion of the support, extending up the leg 1 of the horse only partially surrounds the leg 1 of the horse in such a way that the support only extends around the back of the horse's leg 1. Consequently, support is provided only where necessary to ensure that any limitation on movement is kept to a minimum. The extensor tendon at the front of the horse's leg 1 is rarely damaged even when horse's leg 1 is under high stress levels.

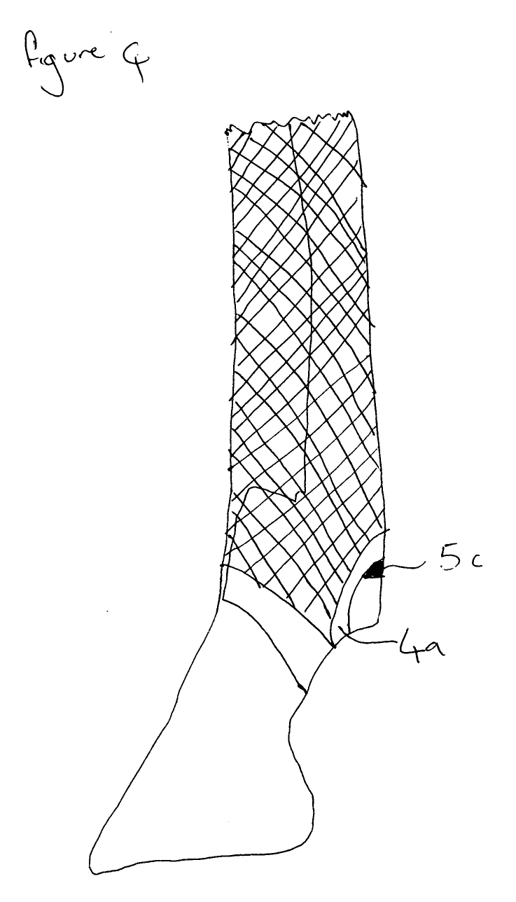

Furthermore, the third layer of fabric (see FIG. 4) provides sufficient support for the extensor tendon. The support is also open around the front boot area of the leg 1 to allow full mobility of the fetlock joint whilst providing maximum support for the tendons and ligaments that are at high risk.

FIG. 4 shows the third layer of the support which comprises a layer of fabric such as four-way stretch Lycra™. The fabric is formed as a mesh to disperse the stress evenly over the leg 1. The fabric is breathable and hard-wearing. An aperture 4a is formed in the fabric to allow the fetlock to protrude therethrough. The aperture is approximately three inches by three inches.

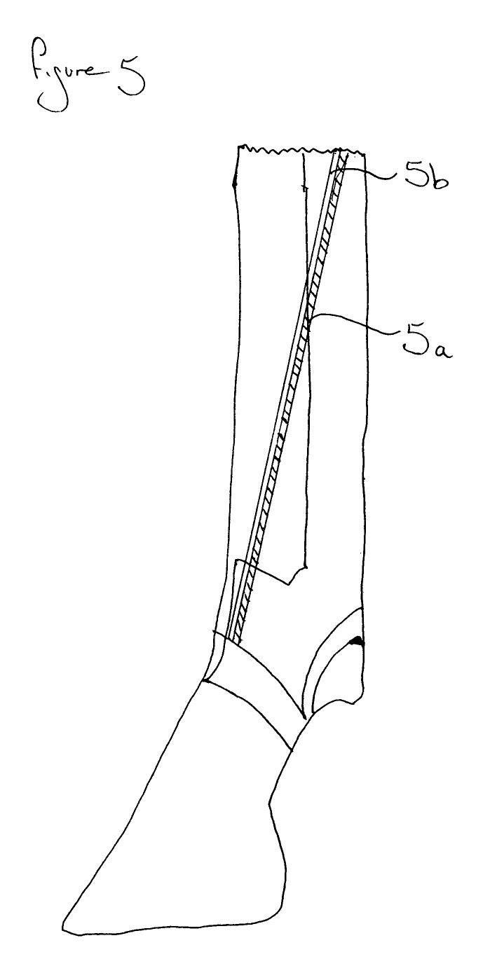

As can be seen from FIG. 5, the support is retained on the leg 1 via a zip 5a. Two further runners are provided along the length of the zip allowing the support to be tightened if necessary. The zip 5a is angled at 45 degrees running upwardly from the bottom side of the fetlock joint to just below the back of the knee. A fabric flap 5b extends along the length of the zip 5a and can be located over the zip 5b to protect the zip from mud and dirt. The flap 5b may be retained over the zip by Velco™ or the like.

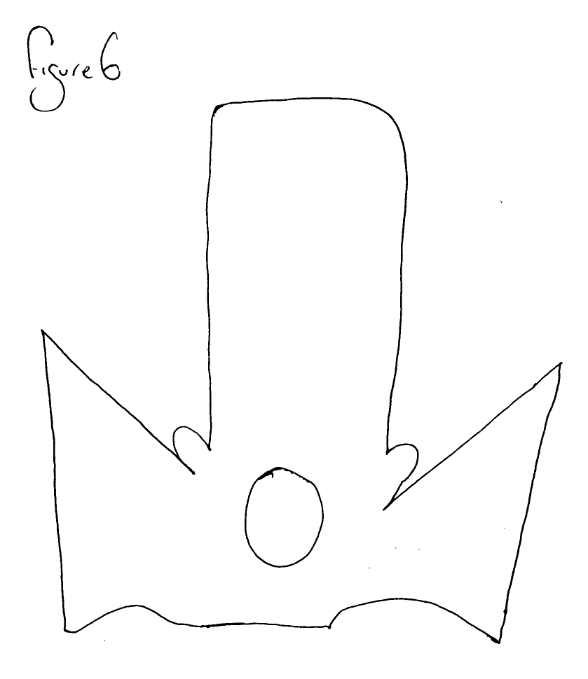

FIGS. 6 to 8 illustrate the shape and design of the support when laid flat.

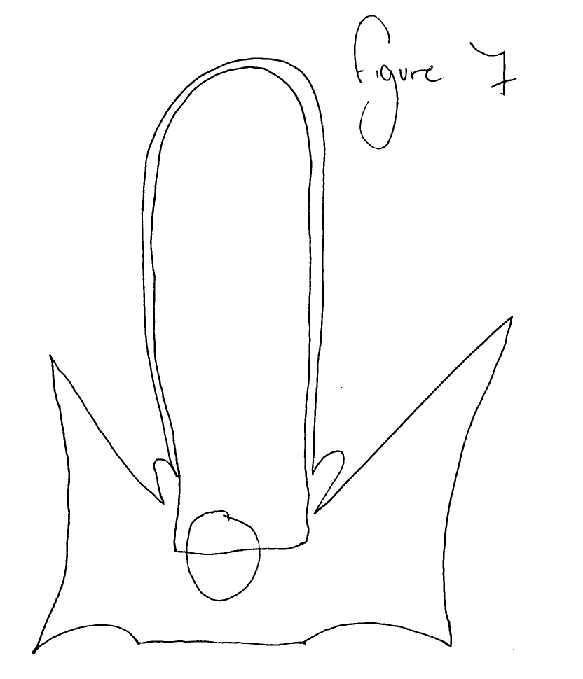

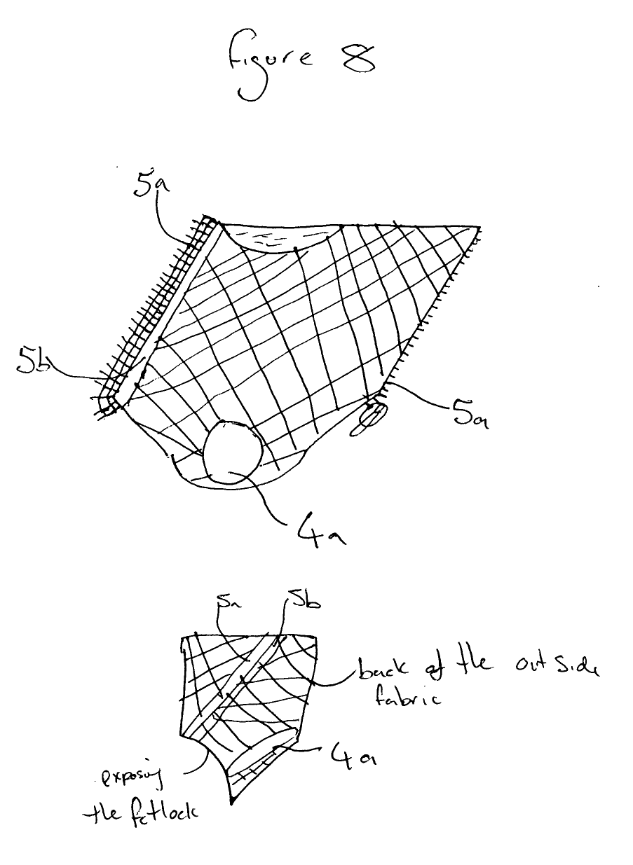

FIG. 6 shows just the second layer of the support dry flex material). FIG. 7 shows the gel underneath the dry flex. FIG. 8 shows the support with the zips 5a attached.

The above described embodiments have been given by way of example only, and the skilled reader will naturally appreciate that many variations could be made thereto without departing from the scope of the present invention.

1. A support for supporting inter alia tendons and/or ligaments of an equine, the support comprising a first layer of supporting gel, a second layer of dry-flex material at least partially overlying the first layer and a third of lycra material at least partially overlying the second layer.

2. A support according to claim 1 wherein, in use, the gel is located between the knee and the fetlock joint of the equine and the dry-flex layer, in use, covers the tendon area at the rear of the leg around the fetlock joint and rear of the long and short pastern.

3. A support according to claim 2, wherein the second and third layers have an aperture formed therein to allow the fetlock to protrude therethrough.

4. A support according to any one of claims 1 to 3, wherein, in use, the gel moulds to the leg of the equine to support the tendons and ligaments over which the gel lies.

5. A support according to claim 4, wherein the gel is chosen to also provide shock absorption.

6. A support according to any preceding claim, wherein the third layer is formed as a mesh.

7. A support according to any preceding claim, wherein the support further comprises at least one zip mechanism.

8. A support according to claim 7, wherein the or each zip is extends upwardly along the support at and angle of 45 degrees.

9. A support as substantially hereinbefore described and referred to in FIGS. 2 to 8.
